(19) United States
(12) Patent Application Publication
(10) Pub. No.: US 2009/0072610 A1
(43) Pub. Date: Mar. 19, 2009

(54) METHOD OF PROVIDING A DECORATIVE MEMBER ON A TOOTHBRUSH

(76) Inventors: Alan Vincent Sorrentino, Cranbury, NJ (US); Robert Moskovich, East Brunswick, NJ (US)

Correspondence Address: COLGATE-PALMOLIVE COMPANY, 909 RIVER ROAD, PISCATAWAY, NJ, 08855, US

(21) Appl. No.: 11/855,564

(22) Filed: Sep. 14, 2007

(51) Int. Cl. B05D 5/06; A46D 3/00

(52) U.S. Cl. 300/21; 427/2.29

(57) ABSTRACT

A method of providing a decorative member on a toothbrush includes the steps of forming an opaque first portion of a handle, putting a decorative member on the opaque first portion; and securing a transparent second portion to the first portion, with the decorative member being positioned between the first and second portions and visible through the second portion.

### FIELD OF THE INVENTION

This invention relates generally to toothbrushes, and, in particular, to a method of providing a decorative member on a toothbrush.

### BACKGROUND OF THE INVENTION

Decorative members, such as logos, symbols, or other designs, are often applied to toothbrushes. In certain toothbrushes, the decorative member is formed by providing a raised portion on the exterior surface of the toothbrush, which can often be difficult to see. Other decorative members are printed or stamped directly on the exterior surface of the toothbrush. In other toothbrushes formed of two materials, a decorative member may be formed by flowing one color of material into a void or recess created in the other material.

It would be desirable to provide a decorative member on a toothbrush in a manner that reduces or overcomes some or all of the difficulties inherent in prior known methods. Particular objects and advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide a method of providing a decorative member on a toothbrush. In accordance with a first aspect, a method of providing a decorative member on a toothbrush includes the steps of forming an opaque first portion of a handle, putting a decorative member on the opaque first portion; and securing a transparent second portion to the first portion, with the decorative member being positioned between the first and second portions and visible through the second portion.

In accordance with another aspect, a method of providing a decorative member on a toothbrush includes the steps of forming an opaque first portion of a handle; securing a decorative member to a surface of the opaque first portion; overmolding a transparent second portion to the first portion, the decorative member being positioned between the first and second portions and visible through the second portion; and securing tooth cleaning elements to a head of the handle.

In accordance with a further aspect, a method of providing a decorative member on a toothbrush includes the steps of forming an opaque first portion of a handle formed of plastic; securing a decorative member to a surface of the opaque first portion;

overmolding a transparent second portion formed of a thermoplastic elastomer to the first portion, with the decorative member being positioned between the first and second portions and visible through the second portion; and securing tooth cleaning elements to a head of the handle.

Substantial advantage is achieved by providing a method of providing a decorative member on a toothbrush. For example, such a method can improve the visibility of the decorative member, as well as insuring that the decorative member cannot be easily removed.

These and additional features and advantages disclosed here will be further understood from the following detailed disclosure of certain embodiments.

### BRIEF DESCRIPTION OF THE DRAWINGS

FIG. 1 is a perspective view of a toothbrush formed of a first portion and a second portion and having a decorative member.

FIG. 2 is a section view of the toothbrush of FIG. 1, taken along line 2.

FIG. 3 is a section view of an alternative embodiment of a toothbrush with a decorative member.

The figures referred to above are not drawn necessarily to scale and should be understood to provide a representation of particular embodiments of the invention, and are merely conceptual in nature and illustrative of the principles involved. Some features of the toothbrush with a decorative member depicted in the drawings have been enlarged or distorted relative to others to facilitate explanation and understanding. The same reference numbers are used in the drawings for similar or identical components and features shown in various alternative embodiments. Methods of providing a decorative member on a toothbrush as disclosed herein would have configurations and components determined, in part, by the intended application and environment in which they are used.

### DETAILED DESCRIPTION OF CERTAIN PREFERRED EMBODIMENTS

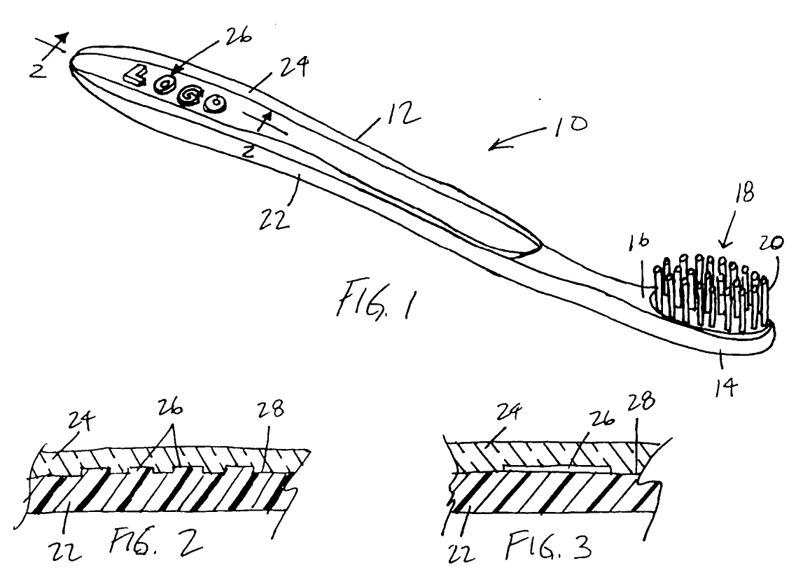

FIG. 1 illustrates an oral care implement, such as a toothbrush 10, having a handle 12 and a head 14, which may be used for cleaning the teeth and soft tissue in the mouth, such as the tongue, interior surfaces of the cheeks, lips or the gums. Handle 12 is provided for the user to readily grip and manipulate the toothbrush, and may be formed of many different shapes and constructions. Head 14 has a first surface 16 that supports tooth cleaning elements 18.

As use herein, the term “tooth cleaning elements” includes any type of structure that is commonly used or is suitable for use in providing oral health benefits (e.g., tooth cleaning, tooth polishing, tooth whitening, massaging, stimulating, etc.) by making intimate contact with portions of the teeth and gums. Such tooth cleaning elements include, but are not limited to, tufts of bristles 20, as illustrated here, that can be formed to have a number of different shapes and sizes, and elastomeric cleaning members that can be formed to have a number of different shapes and sizes, or a combination of both tufts of bristles and elastomeric cleaning members. Cleaning elements 18 may be arranged on first surface 16 in any configuration.

Bristle tufts 20 may be arranged by any conventional method. For example, bristle tufts 20 may be stapled to head 14. In certain embodiments, tooth cleaning elements 18 in the form of strands or bristles can be attached via in-mold tufting (IMT) methods that generally require small cross-sections of material into which the strands are permanently attached. The strands utilizing IMT methods may be attached during formation of the handle 12 or during formation of head 14, which is the portion of toothbrush 10 to which the strands and other materials are attached.

In other embodiments, tooth cleaning elements 18 in the form of strands or bristles may be attached via anchor free tufting (AFT). In the AFT brush making process, described in detail in U.S. Pat. No. 6,779,851, nylon is fed into a pre-molded plate that can be made from any thermoplastic or elastomer material or combination thereof. This nylon may be processed into bristle tufts of various sizes and shapes. The non-use or proximal end of the nylon is heated and melted to retain the nylon in the brush head when a reasonable pulling force is applied. This head plate may then be ultrasonically welded to a pre-molded handle that has a peripheral wall or frame on which the head plate will rest and become fused to the handle.

In the illustrated embodiment, handle 12 is formed of a first portion 22 and a second portion 24. In certain embodiments, first portion 22 is formed of an opaque material, such as plastic. First portion 22 may be formed of any opaque material that can be formed by a molding process. Second portion 24 is a transparent material and may be formed of a thermoplastic elastomer in certain embodiments. Second portion 24 may be formed of any transparent material that can be formed by a molding process. Other suitable materials for first portion 22 and second portion 24 will become readily apparent to those skilled in the art, given the benefit of this disclosure.

A decorative member 26 is provided on first portion 22 and is advantageously visible from the exterior of toothbrush 10 through transparent second portion 24. Decorative member 26 may be any desired element. For example, decorative member 26 may be a corporate logo. In certain embodiments, decorative member 26 may include one or more alphanumeric characters alphanumeric characters, allowing words and/or numbers to be displayed on toothbrush 10. In other embodiments, decorative member 26 may be a combination of a logo or any other design element in combination with one or more alphanumeric characters. It is to be appreciated that decorative member 26 may be any desired symbol, design, graphic element, or any other image, or any combination thereof.

In the embodiment in FIGS. 1-2, first portion 22 is molded, with decorative member 26 being formed as a unitary part of first portion 22 during the molding of first portion 22 such that decorative member 26 is raised with respect to an upper surface 28 of first portion 22. In other embodiments, as seen in FIG. 3, decorative member 26 is a separate element placed on upper surface 28 of first portion 22. Such a decorative member 26 could be printed or hot-stamped on upper surface 28 of first portion 22, for example. In other embodiments, decorative member 26 could be adhesively secured to first portion 22. Other suitable methods of securing decorative member 26 to first portion 22 will become readily apparent to those skilled in the art, given the benefit of this disclosure.

Thus, while there have been shown, described, and pointed out fundamental novel features of various embodiments, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A method of providing a decorative member on a toothbrush comprising the steps of:
forming an opaque first portion of a handle;
putting a decorative member on the opaque first portion; and
securing a transparent second portion to the first portion, the decorative member being positioned between the first and second portions and visible through the second portion.

2. The method of claim 1, wherein the decorative member is a logo.

3. The method of claim 1, wherein the decorative member is a symbol.

4. The method of claim 1, wherein the decorative member comprises at least one alphanumeric character.

5. The method of claim 1, wherein the decorative member is printed on the first portion.

6. The method of claim 1, wherein the decorative member is hot stamped on the first portion.

7. The method of claim 1, wherein the decorative member is a molded as a unitary piece of the first portion.

8. The method of claim 1, wherein the first portion is molded.

9. The method of claim 1, wherein the first portion is formed of plastic.

10. The method of claim 1, wherein the second portion is formed of plastic.

11. The method of claim 1, wherein the second portion is formed of a thermoplastic elastomer.

12. The method of claim 1, wherein the second portion is overmolded on the first portion.

13. The method of claim 1, further comprising the step of providing a head at an end of the handle.

14. The method of claim 1, further comprising the step of providing tooth cleaning elements extending outwardly from a surface of the head.

15. The method of claim 14, wherein the tooth cleaning elements are bristles.

16. A method of providing a decorative member on a toothbrush comprising the steps of:
forming an opaque first portion of a handle;
securing a decorative member to a surface of the opaque first portion;
overmolding a transparent second portion to the first portion, the decorative member being positioned between the first and second portions and visible through the second portion; and
securing tooth cleaning elements to a head of the handle.

17. A method of providing a decorative member on a toothbrush comprising the steps of:
molding an opaque first portion of a handle, the first portion being formed of plastic;
securing a decorative member to a surface of the opaque first portion;
overmolding a transparent second portion of the handle to the first portion, the second portion being formed of a thermoplastic elastomer, the decorative member being positioned between the first and second portions and visible through the second portion; and
securing tooth cleaning elements to a head of the handle.
